(19) United States
(12) Patent Application Publication
(10) Pub. No.: US 2015/0106260 A1
(43) Pub. Date: Apr. 16, 2015

(54) SYSTEM AND METHODS FOR GLOBAL BOARDING OF MERCHANTS

(71) Applicant: G2 Web Services, Bellevue, WA (US)

(72) Inventors: Gavin Willard Andrews, Seattle, WA (US); Matt Ward-Steinman, Seattle, WA (US); Edward James Barton, Bothell, WA (US)

(21) Appl. No.: 14/494,414

(22) Filed: Sep. 23, 2014

Related U.S. Application Data
(60) Provisional application No. 61/889,683, filed on Oct. 11, 2013.

(51) Int. Cl. G06Q 20/40

(52) U.S. Cl. CPC G06Q 20/4016
USPC 705/39

(57) ABSTRACT

Systems, apparatuses, and methods for determining if a Merchant should be provided transaction processing services by an Acquirer and/or continue to be provided such services by the Acquirer. In one embodiment, the inventive system and methods permit a more accurate and reliable determination of the risk to an Acquirer presented by a Merchant, based on a risk assessment engine and the described set of data sources.

### CROSS REFERENCE TO RELATED APPLICATION

This application claims the benefit of U.S. Provisional Application No. 61/889,683, entitled “System and Methods for Global Boarding of Merchants,” filed Oct. 11, 2013, which is incorporated herein by reference in its entirety (including Appendix) for all purposes.

### BACKGROUND

The processing of payments for goods or services is an industry with specific risks that depend upon how each element in a network of users and data processors operate. For example, in a typical environment in which a payment is processed there are multiple actors (e.g., consumer, merchant, Issuer, Acquirer, Processing Entities), multiple technologies employed (wireless networks, wired networks, mobile devices, payment cards, payment tokens, etc.), and multiple opportunities for “bad actors” to commit fraud or otherwise take advantage of their position within the overall payment processing environment.

For example, a consumer's payment account information may be improperly accessed and/or used by an entity that hopes to sell that information to another party that intends to use it to attempt a fraudulent transaction. Similarly, a merchant may attempt to disguise relevant information about their operation or about a transaction, in order to be able to conduct a transaction and have it processed in a circumstance in which it would otherwise be rejected. Further, a business may be operating in a manner that violates a term or condition of the payment card processing industry or a specific rule or policy of another relevant organization (e.g., a payment processor such as Visa or MasterCard, or a governmental regulatory group). In each of these situations there is a risk that an entity will do something harmful to one or more of a consumer, to another entity involved in processing payments, or to the reputation of the payment processing industry as a whole.

Because of the risks associated with payment processing and the entities involved in such processing, much effort has been directed to detecting problems in the processing of payment transactions, and to identifying and evaluating the risk posed by entities that are part of the transaction processing environment. In this regard, one of the areas in which an effort to identify and reduce risk has been made is that of evaluating the risk that an Acquirer is exposed to by providing transaction processing services for a Merchant. Typically, before an Acquirer agrees to serve as an agent for the processing of a Merchant's payment transactions (an event sometimes referred to in the industry as “boarding”), they would like to have some assurance that the Merchant has not engaged in fraud, is unlikely to engage in fraud in the future, and is compliant with any relevant regulations or policies. Further, an Acquirer would like to be able to determine the relative risk of “boarding” a Merchant and be able to (re)assess that risk on a regular basis in order to determine if there has been any change since the initial boarding event. In a practical sense, an Acquirer would prefer to be able to perform these risk assessments using a process that takes into account any specific policies of the Acquirer and as much relevant information about the Merchant as can be reasonably obtained or derived. This benefits the Acquirer by reducing the possibility that they will agree to provide services (or continue to provide services) for a Merchant who is likely to conduct fraud (e.g., by attempting to obtain funds from a false transaction) and/or a Merchant that is likely to engage in a valid transaction, but one for which an Issuer or payment processing organization may not agree to provide payment (e.g., a purchase of illegal or other contraband goods or services).

Unfortunately, conventional approaches to determining the risk or potential risk associated with boarding a Merchant and providing transaction processing services suffer from one or more significant disadvantages. These include not being able to identify potential Merchant risk accurately enough when deciding whether to board a new Merchant and/or deciding whether to continue processing transactions for a Merchant. In addition, conventional approaches are typically slow and inconsistent because of the use of manual intervention and subjective decision making. Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for determining if a Merchant should be provided transaction processing services by an Acquirer and/or continue to be provided such services by the Acquirer. In one embodiment, the inventive system and methods permit a more accurate and reliable determination of the risk to an Acquirer presented by a Merchant, based on the inventive risk assessment engine and the described set of data sources.

In one embodiment, the invention is directed to a method of implementing a process to determine a risk posed by a Merchant to an Acquirer, where the method includes:

accessing information regarding a relationship between the Merchant and its operational environment;

accessing information regarding the business operations of the Merchant;

accessing information regarding the Acquirer's risk control policies;

accessing information regarding the likelihood of a risk event caused by the Merchant;

using the accessed information as an input to an electronic data processing process that generates a model for predicting the likelihood of a specific type of risk event;

accessing information regarding the expected loss to the Acquirer from the specific type of risk event; and

electronically combining the prediction of the likelihood of the specific type of risk event and the expected loss to the Acquirer from the specific type of risk event for one or more types of risk events to generate an aggregate risk score for the Merchant.

In another embodiment, the invention is directed to an apparatus for implementing a process to determine a risk posed by a Merchant to an Acquirer, where the apparatus includes:

a processor programmed to execute a set of instructions;

a data storage element in which the set of instructions are stored, wherein when executed by the processor the set of instructions cause the apparatus to
access information regarding a relationship between the Merchant and its operational environment;
access information regarding the business operations of the Merchant;
access information regarding the Acquirer's risk control policies;
access information regarding the likelihood of a risk event caused by the Merchant;
use the accessed information as an input to an electronic data processing process that generates a model for predicting the likelihood of a specific type of risk event;
access information regarding the expected loss to the Acquirer from the specific type of risk event; and
combine the prediction of the likelihood of the specific type of risk event and the expected loss to the Acquirer from the specific type of risk event for one or more types of risk events to generate an aggregate risk score for the Merchant.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating elements or components of an example payment transaction processing environment in which an embodiment of the invention may be implemented;

FIG. 2 is a diagram illustrating the implementation of an embodiment of the invention in the payment transaction processing environment of FIG. 1;

FIG. 3 is a diagram illustrating elements or components of an example embodiment of the inventive Boarding Risk Assessment Platform illustrated in FIG. 2;

FIG. 4 is a diagram illustrating aspects of a risk assessment scoring model that may be used in implementing an embodiment of the invention; and

FIG. 5 is a diagram illustrating elements or components that may be present in a computing or data processing device configured to implement a process, method, operation, or function in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or later developed technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc. that is part of a client device, server, network element, data processing platform, or other form of computing device) that are programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the present invention are directed to systems, apparatuses, and methods for determining the risk or risks posed by a Merchant to an Acquirer as a result of the Acquirer agreeing to process payment transactions for that Merchant and to prescribing business actions that may be used to mitigate risk and maximize profit. Embodiments of the invention may be used to:

(a) establish a baseline risk level prior to the Acquirer processing a transaction or a substantial number of transactions for the Merchant;

(b) evaluate the risk level at any point in the Acquirer-Merchant relationship using up-to-date risk assessment models and data;

(c) identify Merchants whose risk level has changed in an important way since a previous risk assessment;

(d) determine if an Acquirer should institute a risk mitigation or other form of risk management process with regards to a Merchant based on (c);

(e) identify factors that may be used to “predict” the likelihood that a Merchant has engaged, is presently engaging, or may engage in improper activities, and hence aid in the detection of such activities;

(f) identify the risk posed to the Acquirer by all (or a subset of all) of the Merchants for whom it provides transaction processing services as a way of determining if that risk exposure is acceptable or if the Acquirer desires to make changes to its business operations in order to reduce its exposure to risk from the portfolio of Merchants that it provides services for;

(g) perform due diligence on a portfolio of merchant accounts owned by an acquirer before purchasing the portfolio or owning institution in order to determine the risk presented by the portfolio; or

(h) prescribing one or more business actions that may be used to mitigate merchant risk and/or maximize merchant profit based on the level of risk.

Note that the inventive system and methods may be used for both card present and card not present type payment transactions (such as may occur when a purchase is made via a Merchant's eCommerce web-site). In one embodiment the inventive system and methods may be used to provide a risk assessment during a “boarding” process, and do so in a more accurate and efficient manner than conventional approaches.

Prior to describing one or more embodiments of the inventive system and methods, and the context in which they may be used, the following definitions or descriptions will be presented. In the context of the present document, the following terms have the indicated meanings:

A “payment device” or “portable consumer device” may include any suitable device capable of being used to provide payment for a transaction. For example, a payment device can take the form of a card such as a credit card, debit card, charge card, gift card, or a combination thereof. The card or substrate may include a contactless element in which is stored payment account data. Further, a payment device may take the form of a device other than a card which incorporates a data storage element in which is contained data (e.g., a payment account number, user identification data, etc.) that may be used to conduct a payment transaction. Examples of such devices include mobile phones, PDAs, portable computing devices, etc.

A “payment processing network” (e.g., VisaNet™) is one or more entities (e.g., data processing elements) that are capable of communication and data transfer over a suitable communication network or networks, and which is used to perform operations involved in the processing of payment transactions. A payment processing network may include data processing subsystems, networks, and operations used to support and deliver transaction authorization services, consumer authentication services, exception file services, and clearance and settlement services. Payment processing networks are able to process credit card transactions, debit card transactions, and other types of commercial transactions.

An “authorization request message” may be generated by an entity (e.g., a Merchant) that is part of or in communication with a payment processing network as part of the process of obtaining authorization to conduct a payment transaction. Such a message can include a request for authorization to conduct the payment transaction and may include an Issuer account identifier. The Issuer account identifier may be a payment card account identifier associated with a payment card. The authorization request message may request that an Issuer of the payment card (or payment device) authorize a transaction. An authorization request message according to an embodiment of the invention may comply with ISO 8583, which is a standard for systems that exchange electronic transactions made by cardholders using payment cards.

An “authorization response message” may be a message that includes an authorization code, and may typically be produced by an Issuer in response to receiving and processing an authorization request message as part of determining whether to approve or deny a requested transaction. Other entities or elements that are part of or in communication with a payment processing network may also be involved in determining whether to approve or deny a requested transaction, and/or in adding information to or otherwise modifying such a response message.

A “server computer” may be a computer or a cluster of computers. For example, a server computer can be a large mainframe, a minicomputer cluster, or a group of servers functioning as a unit. In one example, a server computer may be a database server coupled to a Web server. A server computer may be a dedicated data processing platform that is in direct communication with a Merchant and/or an Acquirer, or may be a “cloud-based” platform that is accessed by the Merchant and/or Acquirer.

A “terminal” (e.g., a point-of-service (POS) terminal) can be any suitable device configured to allow a consumer or Merchant to initiate (and in some cases, process) a payment transaction, such as a credit card or debit card transaction, a load transaction, or an electronic settlement transaction. The terminal may include optical, electrical, or magnetic elements configured to read data from portable consumer devices such as smart cards, a keychain device, cell phones, payment cards, security cards, access cards, and the like.

An “Acquirer” is a business entity (e.g., a commercial bank) that typically has a business relationship with a Merchant and receives some or all of the payment transactions from that Merchant for processing and for interacting with an appropriate Issuer via a payment processing network. Typically, the Merchant may have one or more accounts with the Acquirer into which payments are deposited for sales made by the Merchant.

An “Issuer” is a business entity which issues a card or other form of payment device to a consumer or card holder. Typically, an Issuer is a financial institution such as a bank or credit union which manages the payment account associated with the payment device and provides account administration services to the consumer.

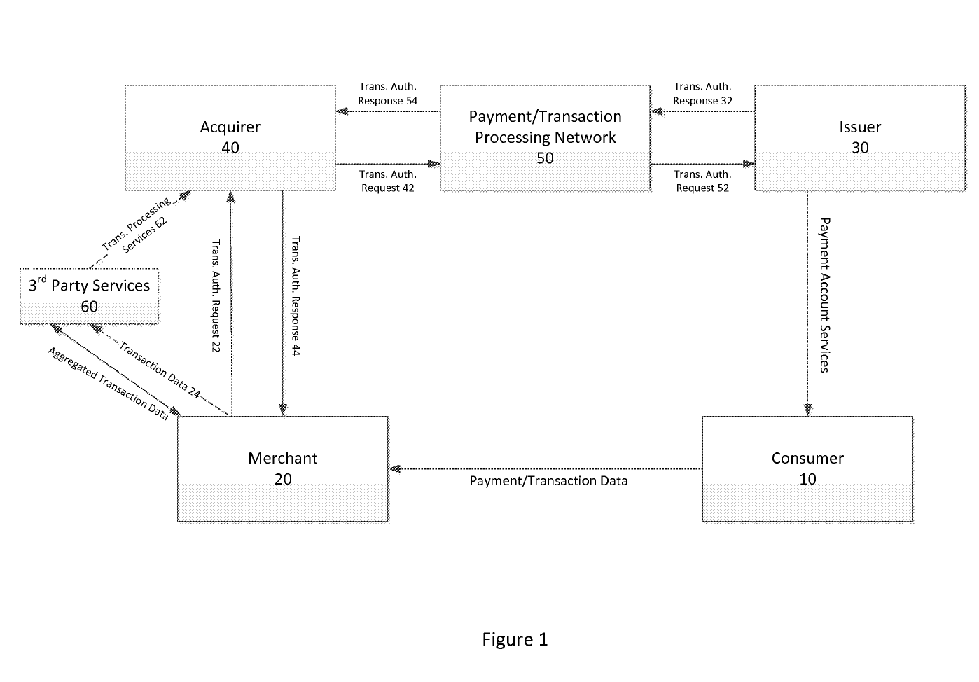

FIG. 1 is a diagram illustrating elements or components of an example payment transaction processing environment in which an embodiment of the invention may be implemented. As shown in the figure, in a typical payment transaction a Consumer 10 interacts with a Merchant 20 (e.g., a “brick and mortar” business or an on-line business) to purchase a good and/or a service. Consumer 10 may pay for the transaction using a physical payment device (e.g., a credit, debit card, or gift card), by providing payment account information (such as account number, date of expiration, Issuer, name associated with account, etc.) by entering data into a form, web-page, or by causing such data to be presented (e.g., by using a mobile device or mobile application, such as a smart card, mobile phone containing a secure data storage element in which is stored payment account information, etc.). The payment account or payment device is provided to Consumer 10 by an Issuer 30, which is typically a bank or credit union that sets up and administers accounts for customers.

Merchant 20 is provided with payment transaction processing services by an Acquirer 40, which is typically a commercial bank that provides banking and transaction processing services to businesses. The Acquirer and Issuer typically communicate with a Payment Processing Network 50 or organization (such as Visa or MasterCard) which serves to securely transfer data, perform certain data processing operations, and assist in the clearance and settlement functions used to distribute funds after a transaction is completed (such as by enabling a transfer of funds between the customer's account maintained by an Issuer and the Merchant's account maintained by the Acquirer).

As noted, Consumer 10 may be associated with (e.g., use) a portable consumer device that is used to make a payment for goods, products, or services. Example portable consumer devices include credit cards, debit cards, and prepaid cards (e.g., gift cards or payroll cards). The portable consumer device may also be in a form factor other than a card. For example, a portable consumer device may be hand-held and compact so that it can fit into a consumer's wallet and/or pocket (e.g., pocket-sized). Examples of portable consumer devices may include smartphones, cellular phones, personal digital assistants (PDAs), pagers, security cards, access cards, smart media, transponders, and the like. The portable consumer devices may interface with a point of service (POS) terminal or payment data (termed “Payment/Transaction Data” in FIG. 1) may be communicated to Merchant 20 by means of Consumer 10 entering data into a web-page or causing a transfer of payment account data from a data storage element to the Merchant. For example, when used with a POS terminal, a contactless system such as an RF (radio frequency) device recognition system or a contact system such as a magnetic stripe may be used to interface with a POS terminal containing a contactless reader or a magnetic stripe reader, respectively. Similarly, if the consumer is conducting an eCommerce transaction (i.e., on-line by visiting a Merchant's web-site), then instead of interfacing with a physical POS terminal, the consumer may enter data into an on-line form, authorize release of payment account data from a data storage location in which it has been previously stored, or use any other suitable method (such as transmitting payment account data wirelessly from a device to a suitable receiver).

Payment/Transaction Processing Network 50 may comprise or use a payment processing network such as VisaNet™. Payment Processing Network 50 and any communication network that communicates with Payment Processing Network 50 may use any suitable wired or wireless network technologies and protocols, including the Internet. Payment Processing Network 50 may be adapted to process debit card or credit card transactions, whether derived from card present or card not present transactions. A payment processing network may include a plurality of data processing devices, such as computers, servers, or central processing units that are interconnected by a suitable network or networks and associated network elements (e.g., Gateway Servers, etc.). The data processing devices may be used to support transaction authorization, clearance, and settlement services for users of the payment processing network, where these services may be applied as needed to various types of transactions, and typically are described as including:

Authorization—the necessary functions or operations to enable an Issuer to approve or decline a transaction before a purchase is finalized or cash is disbursed or transferred;

Clearance—the necessary functions or operations to support the process of delivering a transaction from an Acquirer to an Issuer for posting to a consumer's account; and

Settlement—the necessary functions or operations to support the process of calculating and determining the net financial position of each party for all transactions that are cleared (e.g., transferring funds from a consumer account administered by an Issuer to a merchant account administered by an Acquirer).

The authorization, clearance, and settlement functions are typically performed by exchanging messages between the elements of the payment processing network and the entities that interact with that network (such as the Acquirer and Issuer). Depending on the function being performed and the type or format of a message, a message may contain information about one or more of: (1) the transaction (e.g., the date, type of transaction, amount of transaction, Merchant name, etc.); (2) the consumer conducting the transaction (e.g., the consumer's payment account number, security code, etc.); (3) the Merchant with whom the consumer is conducting the transaction (e.g., a merchant code, category, or other identification, etc.); or (4) the status of the processing of the transaction (e.g., a flag or indicator of whether the transaction has been approved or declined, etc.). A message may also include information about the transaction that is used by the elements of the payment processing network and/or the entities that interact with that network to perform their respective data processing functions (e.g., data that may be used as part of determining a risk value or fraud score, etc.). The messages typically have a format or structure in which certain information is found in a defined field or region of the message. In addition to one or more defined fields, a message may also include one or more discretionary fields in which other forms or types of data may be placed.

As shown in FIG. 1, in a typical transaction a Consumer 10 visits a Merchant 20 (in person or by accessing the Merchant's web-site) in order to arrange to purchase a product or a service. Consumer 10 provides payment for the purchase in the form of either cash or a payment device (which may be a credit card, debit card, or other form of device linked to a consumer payment account). The payment method is indicated by “Payment/Transaction Data” in the figure. If the payment method is not cash, then approval of the purchase transaction may be required. In such a situation Merchant 20 generates a message that serves as a request for Issuer 30 to authorize the proposed transaction (identified as “Trans. Auth. Request 22” in the figure). The Transaction Authorization Request 22 message is provided by the Merchant's data processing system to the Merchant's Acquirer 40, which manages the Merchant's account. Acquirer 40 may process the authorization request message and then route the processed message (identified as element 42) to Payment/Transaction Processing Network 50. Note that Acquirer 40 may add information to or otherwise modify message 22 before routing it as message 42 to Network 50.

Payment Processing Network 50 is typically a group of servers or data processing devices connected by a suitable data communications network that is used to process transaction requests, route messages, perform transaction approval and fraud detection functions, and participate in the settlement and clearance of payment transactions. Payment Processing Network 50 may be operated by a card association such as Visa (e.g., VisaNet). Payment Processing Network 50 may process message 42 before providing the processed message (identified as “Trans. Auth. Request 52” in the figure) to Issuer 30. Transaction Authorization Request Message 52 may contain additional information provided by Network 50 and used by Issuer 30 to determine if a proposed transaction should be authorized (such as data or a risk assessment that is not directly available to Issuer 30). Issuer 30 evaluates the request for the transaction and determines if authorization will be granted. After processing, Issuer 30 generates a response message that includes an indication of whether the transaction has been approved or denied (identified as “Trans. Auth. Response 32” in the figure).

Transaction Authorization Response Message 32 is routed from Issuer 30 to Payment Processing Network 50 and from Payment Processing Network 50 (after additional processing, if customary as part of the approval or transaction evaluation process) to Acquirer 40 (identified as “Trans. Auth. Response 54” in the figure). Transaction Authorization Response message 54 is then routed from Acquirer 40 to Merchant 20 (identified as “Trans. Auth. Response 44” in the figure). If the transaction is approved, then Merchant 20 may inform Consumer 10 and proceed with the overall transaction. If the transaction is denied, then Merchant 20 may inform Consumer 10 and request another form of payment.

As recognized by the inventor, the electronic payments processing industry includes a complex and interrelated set of Payment Processing (Card) Networks, Acquiring Banks, Issuing Banks, Merchants, and many types of third party service providers. There are many ways in which these institutions distribute the liability associated with a Merchant originated risk, but very few ways of measuring the likelihood that a risk event of any specific type will take place. Competition within the industry has produced an environment in which very few institutions have visibility into the operations of merchants that they don't directly do business with. This results in many federated and privately owned data sets that lack the breadth and depth to accurately identify patterns that correlate to, and hence might indicate, merchant originated risk.

Further, the proliferation of Internet and mobile technologies (smart cards, smart devices, wireless and wired networks, etc.) is accelerating the speed at which the payments industry is expanding. Acquiring institutions are building services on top of these technologies that offer merchant accounts to smaller and smaller merchants (and in many cases thereby facilitating payment acceptance and processing for what had traditionally been considered a consumer). Competition in this newer merchant space has been driven by fast and user friendly customer experiences, and high volumes of relatively low value accounts. This has forced a modernization of the due diligence and risk evaluation processes typically associated with “boarding” new Merchants (and introduced other risk factors for Acquirers).

Merchant originated risk can take many forms, including merchants who attempt to steal from the system using fraudulent business practices, merchants that sell illegal products or content, hackers that infiltrate merchant information technology to steal credit card numbers, merchant principals that are sanctioned by federal governments, etc. Each of these risks can lead to events that damage the financial institutions or to the payment industry.

In one form, risk is the likelihood that a future event will happen, combined with the impact of the event to the risk holder if it occurs. Most institutions can gauge the impact an event will cause by evaluating their own resiliency and environment, but very few can gauge the likelihood of an event occurring. As recognized by the inventor, there is an ever increasing amount of merchant and transaction related data that can be collected. This increases the challenge of translating the collected data into measurements relevant to risk management processes and operations. There is also increased competition to perform this function efficiently, quickly, with less human intervention, and with greater uniformity.

However, a custom built, automated risk evaluation and boarding policy enforcement system is outside of the available budget for all but the largest of acquiring institutions. This presents an opportunity which embodiments of the inventive system and methods are intended to address.

A relatively recent development of importance to the boarding of Merchants by an Acquirer has been the introduction of additional possible sources of risk into the transaction processing environment. For example, these sources of risk can be one or more data processing entities that engage in processing data related to transactions and that are positioned between a Merchant and an Acquirer (as suggested by the element labeled “3rd Party Services 60” in FIG. 1). Specifically, these additional entities 60 may be responsible for one or more of the functions that occur after an order is placed by a customer, including but not limited to fulfilling an order placed on a Merchant's web-site, performing a type of data processing for an Acquirer, segregating the processing of a transaction into multiple parts, or performing processing for different types of transactions (e.g., card present vs. card not present transactions), etc.

In some situations a 3rd party may function as an intermediary to enable a consumer to initiate a transaction, for example by receiving and processing an order transmitted over a wireless network by a consumer's mobile device and directing data related to that transaction to another node in a network. In such situations the third party may be a possible source of risk (due to a breach of best practices with regards to data control and storage, an intentional act of fraud, network or infrastructure weakness, etc.) apart from the Merchant for whom the third party is providing order processing services. In another example of a possible source of risk, certain of these third party entities may be sources of transactions processed through the Merchant so that to an Acquirer all of the transactions appear to be originating with that single Merchant (this is termed “aggregation” in the industry, and is suggested by the element “Aggregated Transaction Data” in the figure).

As a result of these changes within the industry, there are now many more possible “pressure points” or sources of possible risk in the traditional payment processing environment than were present previously. These points can be the source of attempted fraud, data corruption, theft of proprietary data, denial of service attacks, etc. For example, a 3rd Party Service 60 may receive transaction data 24 from Merchant 20 as part of an agreement with Merchant 20 with regards to the processing or fulfillment of orders originating on the Merchant's web-site. Service 60 may perform one or more data processing operations on received data 24, and thereby generate an output or outputs 62 (identified as “Trans. Processing Services 62” in the figure) which are provided to Acquirer 40 (either directly as suggested in the figure, or indirectly via Merchant 20). In some cases outputs 62 may represent a transaction authorization request, and/or be part of data considered when Acquirer 40 processes such a request. The data typically includes proprietary data about Consumer 10 as well as Merchant 20, and thus may be the target of an attempted theft or other type of misuse. As another example, the third party service may be cooperating with a Merchant to disguise aspects of a transaction in a form of “cleansing” transaction data, so that the product or service being purchased is obscured, the buyer is obscured, etc. This may be an attempt to permit the purchase of contraband or of a legal product or service that is not acceptable under terms of an agreement with a Payment Processing Network, governmental entity, or other entity.

Because of the possible risks from (1) Merchants, (2) those with whom they interact (such as the 3rd party service providers), and (3) the multiple possible transaction and transaction data processing channels, Acquirers are understandably wary of agreeing to process transactions without first performing some sort of analysis to determine the relative risk of “boarding” a new source of transactions (i.e., a Merchant or Merchant group). Further, even after agreeing to begin processing transactions for a Merchant, an Acquirer would find it advantageous to be able to perform a reliable and encompassing review of the business and operational characteristics of a Merchant to ensure that any initial decision to board the Merchant is justified (e.g., that the Merchant has not developed into an unacceptable risk). In addition, an evaluation of those business and operational characteristics at different times may provide a way to predict and/or detect improper actions by a Merchant that were not apparent at the time of initial boarding or by looking at the current characteristics of the Merchant.

In general, a risk manager desires a risk assessment process that is comprehensive enough to protect them against important risk events, while also being relatively inexpensive and fast to implement so that it can be applied regularly, consistently, and effectively to assess the risk posed by new customers, vendors, etc. There is an increasing amount of data that can be collected and analyzed, and this situation increases the challenge of translating the collected data into measurements relevant to (and that can be efficiently used by) risk management processes. In one embodiment, the inventive system and methods select the most relevant data on behalf of an acquiring institution and combine it to provide a risk assessment measure that meets the applicable speed, accuracy, and cost requirements. Note that the relevancy of a data point in this context may be measured by its correlation strength to risk events, the cost of obtaining the data point, and how unique the correlation is compared to alternatives.

For example, in one embodiment, data sources that are applicable to a Merchant's business model, revenue model, commerce technology model, criminal records, financial behavior data, and network relationships are accessed and the data analyzed for the purpose of determining the risk (or relative risk) that the Merchant poses to an acquiring financial institution. In one embodiment, network relationships in this context refers to determining if the merchant in question has other current or expired merchant accounts by examining the “footprint” of data points across the payments network, internet, World Wide Web, and business networks. In one embodiment, a machine learning model may be “trained” with these data sets as well as historical risk event information to create a model that translates otherwise disparate information into a quantitative probability that a specific type of risk event will take place in the future. Such probabilities may be generated for one or more of the most prevalent risk event types, such as fraud, regulatory compliance, or data security risk. These probabilities may then be used by payment industry institutions throughout the Merchant lifecycle to measure risk exposure and prescribe key business processes (such as whether the current risk level justifies a continued relationship, if a trend in the risk level suggests a potential problem, if the behavior of the Merchant's risk score over time is similar to others in the industry or instead suggests an unrecognized problem, etc.).

In one embodiment, a boarding policy for an Acquirer may be implemented by a risk assessment engine, where the output of the engine is based at least in part on the due diligence and risk management policies and practices applicable to the payment industry. For example, a policy rule could be that an acquiring institution collects credit reports for merchant principals (e.g., owners, primary investors, etc.) and assigns higher service fee rates if the average score is below a pre-determined threshold value. In some cases, policies and the resulting prescriptions may be constructed based on tens or hundreds of such information gathering specifications, information comparisons, and threshold values or other tests. The data sources used to evaluate each risk type or category (fraud, regulatory compliance, etc.) are selected based on a correlation between that source and the likelihood of a future risk event, as determined by a process described herein. Relevant merchant attributes may be obtained from the merchant directly and/or from the acquiring institution. The output of the risk assessment engine may be delivered to the acquiring institution in a prioritized work queue for a team of analysts to review, or may be input directly into the acquiring institution's merchant boarding or risk assessment system where it may be used as a factor in making a boarding decision.

The following are examples of possible use cases for an embodiment of the inventive system and methods:
An acquiring institution wants to be able to evaluate the risk that a merchant poses to them at the time of boarding. This will provide information needed to determine business critical parameters, such as: length of probationary period, amount of reserves that should be held, the settlement period, acquirer rates, what types of ongoing risk monitoring should be initiated, etc.;
An acquiring institution wants to be able to evaluate the risk a merchant poses to them at a later time (e.g., on a regular or periodic basis) so that they can determine if they need to change key account parameters or initiate a specific risk mitigation strategy. Research indicates that some merchants will apply for transaction processing services as a legitimate business, only to alter their business model, website, or behavior later and thereby create an increased likelihood of a risk event after boarding. This form of risk monitoring will allow an Acquirer to prioritize its resources towards the merchants that have a changed risk level, thereby maximizing the optimal use of resources;
An acquiring institution wants a risk assessment to be delivered through a decision engine that translates risk directly into one or more prescriptive elements. In one embodiment, the prescriptive elements recommend what the acquiring institution should do with the account based on the risk assessment, such as to board a merchant or not, or to maintain or terminate performing transaction processing services for a merchant (if the risk assessment is performed post-boarding). In the scenario in which boarding the merchant or maintaining services is prescribed, a set of account parameters and risk mitigation elements (or actions) may be prescribed as well. These prescriptive elements are options that can be taken by an acquirer (or conditions imposed on a merchant) to bring the merchant's risk-to-reward ratio into a desired range for the acquirer. For example, such prescriptive elements may be risk mitigation elements (content monitoring frequency, fraud monitoring frequency or methods, expanding due diligence activities, setting risk reserve quantities, setting funding hold durations, employing transaction thresholds, etc.), or revenue generation elements (discount rates, transaction fee quantities, etc.);
An acquiring institution wants a risk assessment to be delivered in a measurement of monetary value (e.g., US Dollars) so that they can calculate a numerical risk to reward ratio for each merchant. Note that each acquiring institution has their own preferred level of risk and reward as a function of merchant, merchant type, transaction types, transaction volume, transaction revenue, etc. Achieving the preferred level requires an accurate measure of risk in the same units as reward, which is conveniently measured in monetary value;
An acquiring institution wants to input parameters that affect the elements that are prescribed by the decision engine. For some acquiring institutions, prescriptive elements such as content monitoring will not apply because of the type of merchants they provide services for. Other acquiring institutions may want to alter the recommendations to reflect a more conservative risk policy. In both of these scenarios the acquiring institution can input their policies into the decision engine and have decisions and prescriptive elements reflect those policies (which may change over time);
An acquiring institution may desire to evaluate the risk of all the merchants it does business with on a periodic basis. This will provide a holistic view of the acquiring business that can be used for strategic planning as well as operational execution. In this case, an Acquirer will be able to determine such things as: how the total risk compares to their risk tolerance, which merchants are outside a desired risk-reward profile, what type of merchants should be boarded in order to achieve the highest risk-reward ratio within their tolerance, or to alter the overall risk profile in a desirable way, etc.;
This type of analysis may also be used to compare the combined risk of a particular Acquirer's portfolio of merchant customers in a business area to that of other Acquirer's customers in the same or a similar business area. For example, an Acquirer may be interested in knowing how the combined risk profile of all of its merchant customers who sell liquor compares to that of another Acquirer's customers in the same type of business. This comparison may assist the first Acquirer to better understand if the risk it has accepted is typical or atypical of the industry; and
This type of analysis may also be used in the case in which an Acquirer is considering the acquisition of another Acquiring institution's portfolio of active merchant accounts. In that case the analysis could be part of a due diligence process performed on the portfolio, so that risk levels could be measured and the impact of merchant account integration better understood.

Note that the methods, functions, processes, or operations performed as part of implementing an embodiment of the invention may be executed by any suitable computing or data processing device or platform, including but not limited to a server, a network of servers, a cloud-based data processing platform (e.g., as a web service or SaaS provider), a dedicated computing device, etc. Thus in one embodiment, the data processing services provided by an embodiment of the invention may be hosted on a distributed computing system made up of at least one, but possibly multiple, “servers.” In this context, a server is a physical computer dedicated to support one or more software applications/services intended to serve the needs of the users of other computers in data communication with the server, for instance via a public network such as the Internet or a private “intranet” network. Depending on the application or computing service that a server provides it could be referred to as a database server, file server, mail server, print server, web server, etc. A web server is most often a combination of hardware and software that helps deliver content, commonly by hosting a website, to client web browsers that access the web server via the Internet.

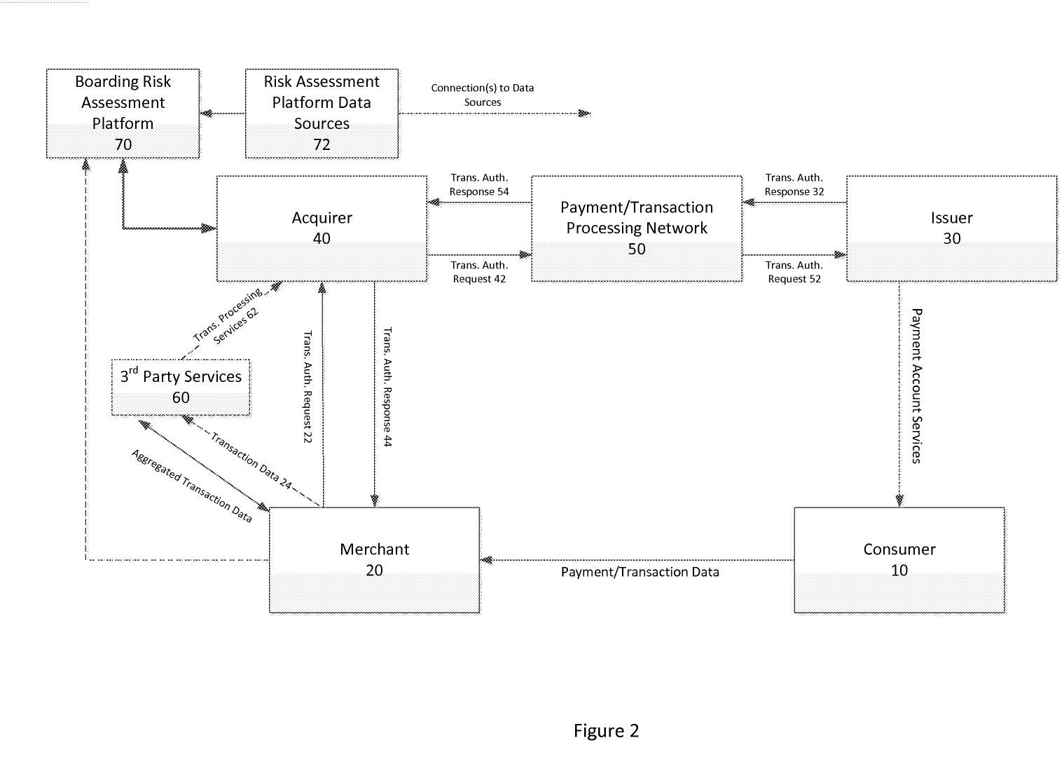

FIG. 2 is a diagram illustrating the implementation of an embodiment of the invention in the payment transaction processing environment of FIG. 1. The architecture depicted in FIG. 2 represents an example of a system in which an embodiment of the invention is implemented in the form of a Boarding Risk Assessment Platform 70. In general, one or more of the operations, methods, processes, or functions of platform 70 may be implemented in the form of a set of software instructions that are designed to be executed by a suitably programmed processing element (such as a CPU, microprocessor, processor, controller, computing device, etc.). In such a system the instructions are typically arranged into “modules” with each such module performing a specific task, process, method, function, or operation. The entire set of modules may be controlled or coordinated in their operation by an operating system (OS) or other form of organizational platform.

The modules and/or sub-modules may include any suitable computer-executable code or set of instructions (e.g., as would be executed by a suitably programmed processor, microprocessor, controller, or CPU), such as computer-executable code corresponding to a programming language. For example, programming language source code may be compiled into computer-executable code. Alternatively, or in addition, the programming language may be an interpreted programming language such as a scripting language.

As shown in FIG. 2, in one embodiment Boarding Risk Assessment Platform 70 is communicatively coupled to Acquirer 40 and may also be coupled to Merchant 20 (as suggested by the dotted line in the figure). In one embodiment, Platform 70 may operate as a SaaS (software-as-a-service) provider of Merchant Risk Assessment services for Acquirer 40. Platform 70 may also function in any other suitable relationship to Acquirer 40 (such as a dedicated server, internally operated application, etc.). Platform 70 operates to implement an embodiment of the inventive risk assessment or merchant boarding risk scoring method based on data it accesses and processes. One or more of these data sources are represented by Risk Assessment Platform Data Sources 72, and may include data obtained from multiple Acquirers, from one or more Payment Processing Networks, from governmental data bases, from private data bases, by accessing the Internet, or from any other suitable source or institution.

In one embodiment, Platform 70 will obtain data from Data Sources 72 and Merchant 20 (with the data obtained from Merchant being obtained directly or indirectly via Acquirer 40 or a Data Source 72), and use that data to determine if the Merchant's characteristics and operations satisfy the Acquirer's boarding policy or policies. If so, then Platform 70 may generate a message to Acquirer 40 informing them of the risk assessment results and/or of the approval of the Merchant for boarding under the Acquirer's policies. However, if the Merchant's characteristics and operations do not satisfy the Acquirer's boarding policy or policies, then Platform 70 may generate a message to Acquirer 40 informing them that the Merchant does not qualify for boarding and if desired, why the Merchant was unable to satisfy the policy or policies.

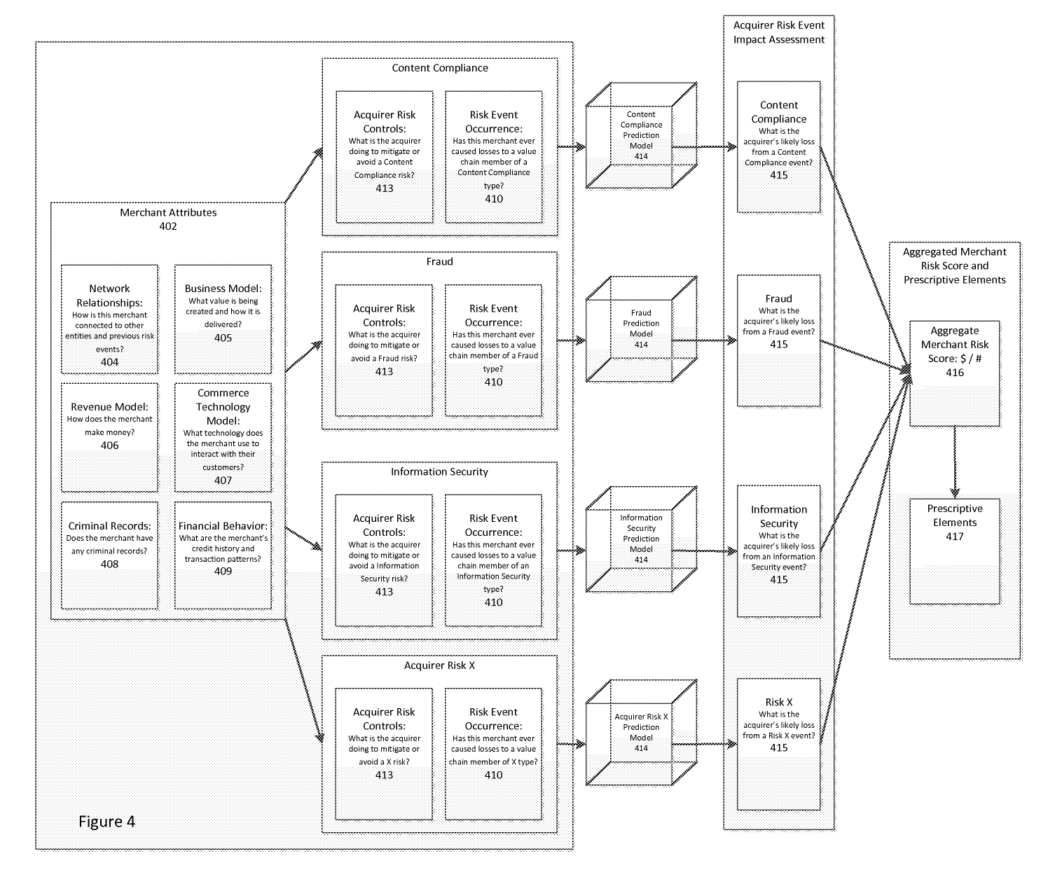

In one embodiment, Platform 70 implements a risk assessment scoring model (such as will be described with reference to FIG. 4) to determine the risk posed by a Merchant and its business operations. The risk assessment scoring model may use any suitable method, process, rule set, algorithm, or heuristic to evaluate the risk posed by the Merchant to an Acquirer, typically by processing one or more sets of data to identify possible indicators of risk or improper behavior by the Merchant. Such methods, processes, rule sets, algorithms, or heuristics may include, but are not limited to machine learning techniques, neural networks, expert systems, decision trees, statistical analysis, etc. The sets of data may include, but are not limited to transaction records, criminal activities records, better business bureau complaints, associations between business names or the principals of a business and other businesses, associations between the internet protocol (IP) address of a computing device and a business or individual, etc. Based on processing these and other sources of publicly and/or privately available data, embodiments of the invention may identify indicators or “predictors” of inappropriate behavior by a Merchant, detect such behavior in a situation in which it would otherwise not have been detected, etc.

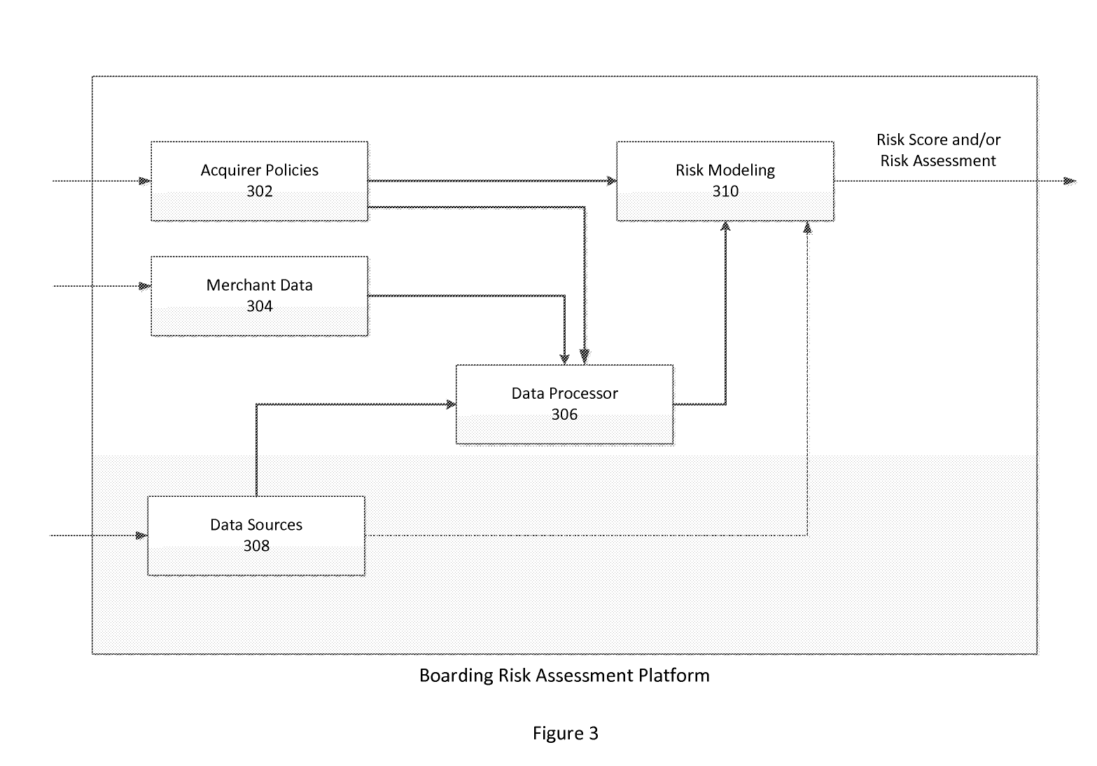

FIG. 3 is a diagram illustrating elements or components of an example embodiment of the inventive Boarding Risk Assessment Platform 70 illustrated in FIG. 2. As shown in the figure, inputs to the platform may include one or more Acquirer Policies 302, which represent one or more rules, “tests”, threshold values, heuristics, algorithms, or other suitable decision making processes or guidance for such processes. Policies 302 represent or codify an Acquirer's method of determining if a Merchant should be “boarded” and/or whether transaction processing services should continue to be provided to that Merchant. The policies may take into account Merchant related data, Acquirer related data, industry related data, public data, private data, or other sources of relevant data. For example, Policies 302 may include a rule or rules for determining if a change in a Merchant's risk profile is significant enough to warrant a warning to the Acquirer, the initiation of a risk mitigation process, the imposition of a term or condition on the transaction processing performed for the merchant, etc. An example policy rule could be that an acquiring institution collects credit reports for merchant principals (owners, part owners, investors, relatives of owners, etc.) and opens an account (or maintains an existing one) as long as the average score is above a pre-determined threshold value. Another policy rule might be to reject any hard goods merchant that does not have a return policy that is accessible to its customers. Note that a typical policy may contain tens or hundreds of such information gathering specifications, information comparisons, and threshold values. Such policies represent codifications of the risk management practices and risk tolerances of the acquiring organization. Merchant Data 304 may be provided to the platform directly from a Merchant being evaluated, via the relevant Acquirer, or by another suitable data source. Merchant Data 304 may include an identification of the Merchant, information regarding the Merchant's web-site address, names under which the Merchant has done or is doing business, data submitted by a Merchant as part of an account application or update process, etc. Policy Data 302 and Merchant Data 304 are provided to Data Processor 306, which is programmed to implement one or more of the inventive processes, methods, functions, or operations that are used to determine the relative risk associated with boarding a new Merchant or continuing to provide services to a Merchant.

External (or stored internal) Data Sources 308 are used by Data Processor 306 and/or Risk Modeling Engine 310 to evaluate the risk associated with merchants that are associated with certain information, to identify those characteristics of merchants that may be used as predictors of later undesirable behavior, and/or to find information about the Merchant being evaluated. A more detailed example of the data processing implemented by Data Processor 306 and/or Risk Modeling Engine 310 will be described herein with reference to FIG. 4. Data Sources 308 typically includes information not obtained from the Merchant, and may include private or public data bases, Internet records, governmental data bases, search results, etc. Based on Data Sources, 308, the outputs of Data Processor 306, and the specific policies of the Acquirer 302, Risk Modeling Engine 310 operates to evaluate the data specific to the Merchant 304 to determine if the Merchant satisfies the policy or policies. This decision may be represented as a Risk Score or other form of Risk Assessment for that Merchant (as suggested by the output of Risk Modeling Engine 310).

FIG. 4 is a diagram illustrating aspects of a risk assessment scoring model that may be used in implementing an embodiment of the invention. In one embodiment, the risk scoring model may be implemented by risk modeling element 310 and data processor 306 of FIG. 3. The scoring model described with reference to FIG. 4 includes several components that enable it to generate a more accurate and reliable risk evaluation compared to conventional processes. These include a rigorous approach to calculating multi-variable correlations (e.g., a machine learning model), a holistic set of risk types, use of acquirer risk control measurements, and the use of acquirer risk damage probabilities. The benefits to using such a comprehensive model include but are not limited to increased accuracy, increased precision, a more holistic merchant risk approach, risk event likelihood measurements tailored to each acquirer, the ability to calculate true risk using a consistent unit of measurement, and generating operational prescriptions that function to create consistent risk mitigation and profit maximizing results. Note that the scoring model illustrated in FIG. 4 may be used in the form described or in a form with a reduced set of attributes and/or models in cases where sufficient data is unavailable or is unreliable. As shown in FIG. 4, in one embodiment the following data sources are accessed and risk modeling operations are performed to generate a risk assessment score:

### Merchant Attributes (402)

Network Relationships (404, the merchant's business network)—How is this merchant connected to other entities and previous risk events?
   Example Data Types/Sources
      A set of URLs that have been reviewed in the past and found to be a source of content compliance violations;
      The Merchant Name, Phone Number, Email Address, Physical Address, and URL as submitted by the merchant during account application or account update activities;
      The “Whois” record (the results of querying a database that contains data corresponding to an input URL) for each of the URLs with the Company Name, Physical Address, Phone Number, and Email Address;
      The Merchant Name, Phone Number, Email Address, Physical Address, and URL of each new boarding candidate; and
      The “Whois” record for each new boarding candidate with parsed fields for ease of further processing;
   Processing of Data
      Each merchant data point for a new boarding candidate is searched independently against the merchant data points of previous content compliance violations;
      Each “Whois” record data point for a new boarding candidate is searched independently against the “Whois” record data points of previous content compliance violations; and
      Search techniques include one or more of exact string matching, sub-string keyword matching, and URL part matching;
   Meaning of Results of Processing
      From experience investigating content compliance violations, the assignee of the invention has found that the typical violating business owner will have more than one website and more than one merchant account. It has also been found that when these merchants apply for accounts at different acquirers, they intentionally change data points to avoid being linked to previous failed accounts. By combining merchant data from the payment network and from the Whois network, it is likely that at least one data point will be repeated. Collecting this data and processing it can therefore reveal if a content violator is trying to re-enter the payment system. The same repeat of data points may also occur in the “Whois” records (required to be checked when a domain is registered), thereby providing another method to identify merchants reentering the payment system.
Human Resource Network (may be represented as a subset of 404)—How are individuals in this business connected to other entities and previous risk events?
   Data Types/Sources
      A set of URLs that have been reviewed in the past and found to be a source of content compliance violations;
      The business Principals including their contact data (Phone Number, Email Address, Physical Address) as submitted by the merchant during account application or account data update activities;
      The “Whois” record for each of the URLs with the Contact Names parsed out;
      The “Whois” record for each new boarding candidate with the Contact Names parsed out;
   Processing of Data
      Each merchant application and “Whois” contact name for a new boarding candidate are searched independently against the merchant application and Whois record contact name data points of previous content compliance violations;
      Search techniques may include exact string matching, sub-string keyword matching, and other suitable techniques;
   Meaning of Results of Processing
      From experience investigating content compliance violations, the assignee has found that the typical violating business owner will have more than one website and more than one merchant account. Also, the individual can be used to link new merchant accounts to existing or previously closed merchant accounts that could not be linked by business data points, as described in “Network Relationships” above. Thus, overlaying networks increases the likelihood of identifying the footprint of an organization that is attempting to separate themselves from previous offending behavior or merchant accounts.
Geographical Network (may be represented as a subset of 404)—How does the geography of this business relate to previous risk events?
   Data Types/Sources
      A set of URLs that have been reviewed in the past and found to be a source of content compliance violations;
      The set of IP addresses that these URLs have been on at the time a violation was found;
      The IP address of each new boarding candidate;
      A map of IP addresses to physical locations, which may be purchased on a subscription basis from a 3rd party data provider;
   Processing of Data
      Each IP address for a new merchant is checked against the list of set of IP addresses that have hosted a violating site in the past.
      Each country is assessed a percentage that represents the number of previous violations divided by the total number of merchant websites;
      The physical location of the new boarding candidate site is collected and compared to the assessment data;
   Meaning of Results of Processing
      The assignee has found that violation percentage varies by geography. The cause is uncertain, but may be correlated to a variance in legislation, or perhaps the geographical location of merchant companies that violate content compliance regulations.
Business Model (405)—What value is being created and how is it delivered?
   Data Types/Sources
      The method/process by which the merchant's business creates value, such as: Web Portal, Content Provider, Transaction Broker, Market Creator, Service Provider, Marketplace Merchant, etc.;
   Processing of Data
      The data is collected through research of information published by the merchant, by regulatory bodies, public registries, industry registries, or purchased from data providers;
      It is collected for each merchant being provided risk assessment services and for each new boarding candidate;
   Meaning of Results of Processing
      From experience with the payment industry value chain, the assignee has recognized that the way in which a business creates value correlates to the risk it may create. For example, from an acquirer's perspective, a merchant that is a market creator represents a conglomerate of many merchants, each with their own risk profile. The acquirer can set contractual requirements with the market creator, but likely has no influence over the contracts or policy that governs the merchants that use the marketplace. In contrast, a content provider merchant would likely be self-contained from a risk perspective.
Revenue Model (406)—How does the merchant make money?
   Data Types/Sources
      The method in which the business generates revenue, such as: Advertising, Affiliate Referral, Sales of Goods, Sales of Services, Subscription Fees, Transaction Fees, Self-Supported, etc.;
   Processing of Data
      This data is collected through research of information published by the merchant, by regulatory bodies, public registries, industry registries, or purchased from data providers;
      It is collected for each merchant being provided risk assessment services and for each new boarding candidate;
   Meaning of Results of Processing
      From experience with the payment industry value chain, the assignee has recognized that the way in which a business generates revenue correlates to the risk it may create. Subscription fees, for example, are common in deceptive marketing schemes and can results in chargebacks from unhappy customers and expenses for the acquirer. Affiliate referrals, for example, are the mechanism for affiliate fraud.
Commerce Technology Network (407)—What technological infrastructure does the merchant share with other entities?
   Data Types/Sources
      The technology the business uses to interact with customers, such as: Brick and Mortar, Mail Order Catalog, Telephone Order Catalog, Web Site, E-Commerce Enabled Website, Self-Processing, Service Provider—Payment, Service Provider—Shopping Cart, Mobile Site, Mobile App;
      A set of URLs that have been reviewed in the past and found to be a source of content compliance violations;
      The set of IP addresses that these URLs have been on at the time of detecting a violation;
      The IP address of each new boarding candidate;
   Processing of Data
      This data is collected through research of information published by the merchant, by regulatory bodies, public registries, industry registries, or purchased from data providers;
      The IP Address of each new boarding candidate is searched against the set of IP Addresses of previous content compliance violations; and
      Search techniques may include one or more of exact string matching, sub-string keyword matching, and other suitable techniques;
   Meaning of Results of Processing
      The assignee of the invention has found that some content compliance violators may take down a site after having their merchant account discovered and terminated, then put up a new site. In some cases it has also been found that content violators own the IP address or an entire IP Block on which they host sites. It has also been found that a merchant with at least one content violating site is likely to have more than one. Further, from experience with the payment industry value chain the assignee has recognized that the technology a business uses correlates to the risk it may create. For example, a merchant that operates only as a mail order catalog with a local data system will have a different risk of a data breach than an eCommerce enabled website that allows reads and writes to the data base over the internet;
Criminal Records (408)—Do the merchant principals have criminal records?
   Data Types/Sources
      Public records of convictions of financial crimes;
   Processing of Data
      This data is collected through research, or purchased from data providers;
      It is collected for each merchant being provided risk assessment services and for each new boarding candidate;
   Meaning of Results of Processing
      From experience with the content compliance monitoring and merchant investigations, the assignee has observed that a previous criminal record in financial crimes will be correlated in a meaningful way to the risk a merchant poses to an acquirer.
Financial Behavior (409)—What are the merchant's credit history and transactional patterns?
   Data Types/Sources
      A credit report for the merchant's principals;
      A credit report for the merchant's business;
      A measure of monthly transaction volume;
   Processing of Data
      Credit data is purchased from credit data providers and the monthly transaction volume is collected from acquirers;
      It is collected for each merchant being provided risk assessment services and for each new boarding candidate;
   Meaning of Results of Processing
      An acquirer extends a form of credit to merchant as part of the normal acquirer-merchant relationship. When a consumer makes a purchase of a durable good, for example, the acquirer will typically settle the payment into the merchants account within 1 day, while the delivery of the good may take weeks. During this time period, from the acquirer's perspective, they have essentially loaned the merchant the payment until the consumer is delivered the good they purchased. A credit history and monthly volumes have been found to be correlated in a meaningful way to the risk a merchant poses to an acquirer. For example, transaction data can be used to identify transactions that are abnormal for a merchant, such as large volumes in off business hours (which has been found to be correlated to fraudulent activities). Transaction data can also be used to establish which patterns are common for fraud, rapid growth, new business ventures, pending bankruptcy, and other scenarios that put the acquiring institution at risk.
Acquirer Risk Controls (413)—What is an acquirer is doing to address each risk type?
   Data Types/Sources
      A catalog of each product, service, system, or method an acquirer is using to mitigate each risk type;
   Processing of Data
      This information is collected from acquirers and generalized to a % based on the effectiveness of mitigating risk. The likelihood of a risk occurring (x %) is reduced by the risk control percentage (rc %) such that the resulting likelihood (rl %)=(x %)*(1−rc %);
   Meaning of Results of Processing
      What an acquirer does to address a specific risk will have some effect on the likelihood of that type of risk event occurring. If for example an acquiring institution has a content compliance monitoring program in place that is successful at reducing content compliance risk events by 90%, then the Risk Control value for the content compliance risk is 90%.
Risk Event Occurrence (410)—Has this merchant ever caused a loss to a value chain member of type X? Note that this can be a generic model capable of representing multiple types of risks depending on the input data and training process.
   Determination of X-type Risk
      The X indicates that this concept is applicable to multiple types of risk, such as: Content Compliance, Fraud, Credit Default, Government Regulatory, Information Security Risk, etc.
      Note that in order to make this a Content Compliance model, the Network Relationships attribute group should contain the network relationships to content compliance violations and the risk event occurrence data should be the occurrence of content compliance violations;
      Note that in order to make this a Fraud Risk model, the Network Relationships attribute group should contain the network relationships to fraud risk events and the risk event occurrence data should be the occurrence of fraud risk events, and so on with other risk types
   Data Types/Sources
      For each risk event type, the assignee collects a set of merchants that have caused the event type and a set that have not caused the event type;
      Data is collected from acquiring institutions, service provider partners, research of information published by the merchant, by regulatory bodies, public registries, industry registries, reputable industry news sources, or purchased from data providers;
      As examples:
      Content Compliance model: A set of URLs that have been reviewed in the past and found to include content compliance violations and a set in which no violation was found;
      Fraud model: A set of merchants received from acquirer partners and identified as known fraudsters and a set of merchants not identified as such;
      Information Security model: A set of merchants received from acquirer partners and identified as being responsible for compromised data and a set of merchants not identified as such;
      Regulatory Compliance model: A set of merchants contained on the federal watch lists for financial sanctions and a set of merchants that are not on such lists;
      Credit model: A set of merchants received from acquirer partners and identified as having defaulted and a set of merchants not identified as such;
      Data points collected include all the merchant attributes described above. Also collected are risk event specific details such as which acquiring institution the event occurred to, the magnitude of the loss from the event, the timing of the event, and what actions the acquiring institution took in response to the event;
   Process
      The process is described below in the Training Set/Model section;
   Meaning of Results of Processing
      Knowledge or which merchants have caused risk events is critical for two reasons: (a) first is the use of the risk events to create the Network Relationships data used in the model, which is a measurement of how close a merchant is to merchants with risk events, (b) second is that comparing the patterns in merchant attributes of non-risk event merchants to the patterns in the merchant attributes of risk event merchants reveals which patterns are highly correlated and meaningful in the prediction of future risk events;
Training Set/Model:
   Model Background
      The “models 414” shown in FIG. 4 represent a body of information that includes the following:
      Values that represent the correlation between each attribute value or groups of attribute values and a “measure” or characteristic value;
      Instructions on how to take a set of merchant attributes as input, determine the correlation of each attribute, calculate the collective correlation across all attributes, and output a probability as to the measure's value;
   Training Set
      The training set is data used to calculate the correlations between each attribute value and the measure;
      An initial set of data is selected, for example, several (or more) thousand merchants that were the subject of a content monitoring program started at some time past;
      Data representing merchant attributes as they were at the time the program was initiated for each merchant;
      Data representing merchants that were found to have a content compliance violation or fraud event (or other type of risk event) in the year following the date the program began monitoring those merchants (this was used as the merchant measure);
      In one process, the training set may be split into two groups, with one group being the training set and the other group being the test set;
   Model Building
      Using a suitable machine learning platform and modeling library, input the training set for one risk type (content compliance, for example) and one model type;
      Input the test set into the completed model and compare the predicted risk measure value to the actual value(s);
      Repeat this process with other model types and select the one that produces the most true positives and least false positives; and
      Repeat this process with other risk types until a suitable model is found for each risk type.
      Note that in one embodiment, the problem was treated as a classification problem in which a support vector algorithm was used to process the data.
Acquirer Risk Event Impact Assessment (415)—What is the likely loss if an event occurs?
   Data Types/Sources
      A probabilistic measure of risk event impact is collected from the acquirer for each risk event type;
      This impact includes losses from financial fines, theft, resource expenditure, public relations and brand damage, etc.;
      Acquiring institutions can calculate this as the average cost per risk event type that has occurred;
      Acquiring institutions can also add in weights to create a weighted average that better represents their sensitivity to large events or specific types of risk events;
      Acquiring institutions can instead replace the probabilistic measure of event impact with a simple weight per risk type representing the relative impact of each risk type to their organization;
      The assignee also creates a default value for these factors based on the average cost of each event type to acquiring institutions across the industry;
   Processing of Data
      The measurement collected here for each risk type is combined with the results of the risk event prediction model for the equivalent risk type;
   Meaning of Results of Processing
      This is meaningful because it provides the acquiring institution with an ability to customize the risk assessment based on their loss scenario, which is a reflection of what the institution finds valuable;
      The combination of likelihood of a risk event and the likely cost of a risk event results in a quantitative measurement of risk in the currency used by the acquirer to describe the magnitude of the risk;
      This is meaningful because it allows an acquiring institution to compare different types of risks on the same scale.
Aggregated Merchant Risk Score and Prescriptive Elements (416, 417)
   Data Types/Sources
      The results of combining the risk prediction model results with the risk event impact assessment for each risk type are the inputs for an Aggregate Merchant Risk Score;
   Processing of Data
      Each risk type produces a measurement of the same unit (of currency or relative impact) and is added together to create the Aggregate Merchant Risk Score. This is possible because of the assessment method described herein and the unit (monetary value or relative impact) of the resulting assessments;
      Each risk type measurement may also be translated into a set of prescriptive elements (recommended actions, policies, etc.) that an acquiring institution can follow to mitigate risk of a merchant or to increase the value of a merchant. For example, if a merchant has a high risk of a data security risk event, then the acquiring institution is prescribed to implement a security review process. As another example, if a merchant has a high risk in more than one risk type or a cumulative aggregate risk score of a high enough value, then the acquiring institution is prescribed to not board, or to terminate the merchant.
   Meaning of Results of Processing
      The Aggregate Merchant Risk Score is a comprehensive quantitative probabilistic measurement of the financial risk a merchant poses to an acquirer. Note that the inventive system and model(s) can be expanded to assess the impact of any relevant risk type or merchant attribute while maintaining the same format that facilitates merchant risk measurement at any time in the merchant lifecycle, and accurate merchant-to-merchant comparisons for portfolio level assessments and risk management planning;
      The prescriptive elements generated by the inventive system allow the acquiring institution to directly apply the results of a merchant risk assessment. The elements represent actions, steps, processes, or operational aspects that may be used by the institution to better mitigate and/or manage the most prevalent or serious risks driving the Aggregate Merchant Risk Score. Such prescriptive elements assist in accomplishing automation, uniformity of decision, and reduction of errors caused by use of subjective judgement;
      Note that in some embodiments, the prescriptive elements may take into account other factors, such as the value to an acquirer of the merchant or the merchant's business type, the weights provided to the model by an acquirer with regards to the relative significance of specific types of risks, changes to the merchant's business or to an acquirer's portfolio of risks, etc.

Note that in addition to the data types or sources mentioned, other potentially relevant sources may also be used as part of assessing the risk to an acquirer posed by a specific merchant. For example, the Office of Foreign Asset Controls (OFAC) of the U.S. Federal Government has a Specially Designated Nationals (SDN) list. Financial institutions are not allowed to provide financial services to individuals and organizations on this list. Thus, this source might be accessed and compared to a list of principals or investors in a business to determine if an acquirer should reject that merchant/business as a customer or continued customer.

Note also that in addition to the machine learning models and techniques described herein, other types of models or risk decision models may be used. These include statistical models, models with pre-assigned weights, scoring based models in which specific risk types or data values cause an increment or decrement in a total risk value (which is then compared to a threshold value), etc.

As illustrated by FIG. 4, in one embodiment, the inventive system and methods access data that is used to construct a set of “training” data, with the training data used as inputs to a suitable machine learning process. The data may include data from one or more of the data sources described herein for a specified model or decision process. In a typical embodiment, the inventive system collects or accesses data regarding a type of relationship between a merchant and its operational environment or data regarding the operations or background of the merchant. The data serves to provide information regarding possible sources of risk or indicia of risk.

The data is used to develop a “model” 414 for predicting the likelihood or risk that an event of a specific type will occur. In developing the model, the system also takes into account known information that might impact the likelihood of the event. This may include information regarding controls or processes used by an acquirer to reduce the likelihood of a specific type of risk event 413. Such information may also include information about a loss or losses cause by a merchant that arose from a specific type of risk 410. The combination of the information regarding possible sources of risk or indicia of risk (illustrated as Merchant Attributes 402 in FIG. 4) and possible risk mitigating factors (illustrated as Acquirer Risk Controls 413 and/or Risk Event Occurrence 410 in FIG. 4) are used to generate a “model” 414 for predicting the expected likelihood of a monetary loss to an acquirer arising from a specific type of risk (content compliance, fraud, etc.) due to a particular merchant or set of merchants. This expected likelihood (which may be represented as a percentage or normalized value) is then combined with the expected amount of loss arising from the specific type of risk 415 to generate an aggregate merchant risk score 416.

Thus, in one embodiment, the inventive system may use one or more machine learning techniques (neural networks, decision trees, support vector machines, clustering, statistical analysis, etc.) to operate on a set of training data to produce a “model” that predicts the likelihood of a merchant or set of merchants causing a specific type of risk event. This likelihood is combined with information regarding the likely loss to an acquirer 415 from the risk event(s) to generate an aggregate merchant (or merchants) risk score 416, which in one embodiment represents the expected loss (or cost) to an acquirer arising from one or more types of risk events due to the operations of a merchant or merchants.

Note that the operations, methods, processes, or functions represented by FIG. 4 may be implemented in any suitable manner. For example, the output or outputs of the prediction models 414 may be combined in different ways with the risk event impact assessments 415 to generate the final risk score 416. Such combinations may include a sum of weighted values (Weight 1×Prediction Value 1×Impact 1+Weight 2×Prediction Value 2×Impact 2+ . . . ), the product of one or more terms, a power function of one or more terms, etc. Further, as noted, the models 414 may be generated by any suitable process or technique, including machine learning, statistical analysis, curve fitting, etc.

Based on the Aggregate Score 416 (which may be expressed in a common unit, such as cost or a numerical value), the inventive system may generate one or more prescriptive elements 417. These represent steps, processes, operational aspects, instructions, guidance, recommended actions, etc. that may be used by an institution to control or otherwise manage its risk. The prescriptive elements presented to a particular institution may be a function of the factor or factors found to be most relevant to the score (e.g., to its value, to its sensitivity to increase or decrease, to causing the greatest decrease or limiting its variation, to a change in value, etc.). Note that the aggregate score is a holistic measurement of merchant risk across the various risk types. Some of the prescriptive actions may be based on the combined score, such as “do not board this merchant”, while others may be based on the individual risk types. Examples of possible prescriptive elements, include but are not limited to the following:
a) A high fraud risk may result in a suggestion to “monitor this merchant's transactions for fraudulent behavior” or to “apply greater reserves and longer reserve periods to this merchant”. Monitoring would likely result in faster identification and termination of fraudulent behavior and would be incorporated into the model using the fraud Acquirer Risk Control variable. Increasing reserves would create a larger buffer that must be crossed before losses are accrued and would reduce the fraud Acquirer Risk Event Impact value;
b) A high risk of content violation may result in a suggestion to “monitor this merchant's website content on a weekly basis” or to “periodically check to see if this merchant is operating additional websites through this same account without telling you”. Both monitoring and looking for additional websites would likely result in faster identification and termination of violating content. This would decrease the content violation risk value through the content Acquirer Risk Control variable;
c) A merchant with a high risk of an intellectual property theft content violation may result in a suggestion to “confirm the merchant is licensed to sell the brands it has for sale” or to “confirm with the brand owner that the merchant's products are not counterfeit or pirated”. These two prescriptions would reduce the amount of intellectual property infractions and decrease the content violation risk through the content Acquirer Risk Control variables;
d) A high risk of data security violation may result in a suggestion to “require this merchant to undergo a PCI DSS compliance assessment by a QSA before boarding” or to “require this merchant to switch service providers before boarding”. Both of these prescriptions would limit exposure to vulnerable data technologies and decrease the data security risk value through the data security Acquirer Risk Control variable; or
e) A high Aggregate Score may result in a suggestion to “increase the add-on transaction fee” which increases the per transaction revenue generated for the acquirer. This would create a larger buffer that must be crossed before losses are accrued and would reduce the fraud Acquirer Risk Event Impact value.
   In one embodiment, there may be default ranges of scores that trigger certain prescriptive messages, but an Acquirer may be able to submit their own thresholds to the scoring engine to indicate what risk levels they consider low, medium, and high. An Acquirer may also be able to submit new prescriptions or remove default prescriptions from the set if their business operations differ from what is provided.

Note that depending on the available data sources, their presumed validity, the computational resources available or required, or other considerations, a model of the type illustrated in FIG. 4 may be used as shown, or a reduced form of the model may be used in which certain data sources and/or models are not used and hence do not contribute to the risk evaluation. Similarly, standardized, fixed, or average values may be used for certain data or model outputs instead of removing them from the overall process of generating the aggregate risk score.

As described herein, the inventive system and methods may be used to generate an aggregate risk score for a Merchant or set of Merchants. Such a score may then be used by an Acquirer as part of a decision process regarding boarding or continuing to provide services to the Merchant or Merchants. In one use case, the inventive system and methods may be used to generate a risk score or average risk score for a portfolio of Merchant accounts. This may be used by an Acquirer to evaluate the risk profile of its own portfolio, as part of a process to manage the risk associated with its own portfolio or to evaluate the risk associated with a portfolio being considered for acquisition.

In some embodiments, the inventive system and methods by accessing and processing data sources that have not been used previously or used in the same manner for purposes of Merchant and Acquirer risk evaluation. Another aspect of the inventive system and methods is the use of data from multiple “networks” in order to generate the risk score; these networks include but are not limited to the merchant-acquiring and payment transaction processing network, the World Wide Web, the web entity registration network, the physical Internet architecture, and social or other networks associated with company principals to identify the footprint of organizations that damage the payments industry.

In one embodiment, the inventive system and methods provide a tool to predict the likelihood of one or more types of risk events though historical analysis of merchant behavior, merchant relationships, and other risk factors, and then apply a quantitative risk assessment methodology to that data. This enables the inventive system and methods to generate a holistic merchant-level risk assessment and present that assessment in the form of specific recommended acquirer actions or operations.

The inventive system and methods may be differentiated from conventional approaches by several features, including but not limited to the mapping of risk assessments to prescriptions or recommended actions that are directly actionable by acquirers and the rigor of the inventive risk assessment methodology that considers the likelihood of an event, the controls an acquirer is using to prevent that event, and the impact of the event if it were to occur.

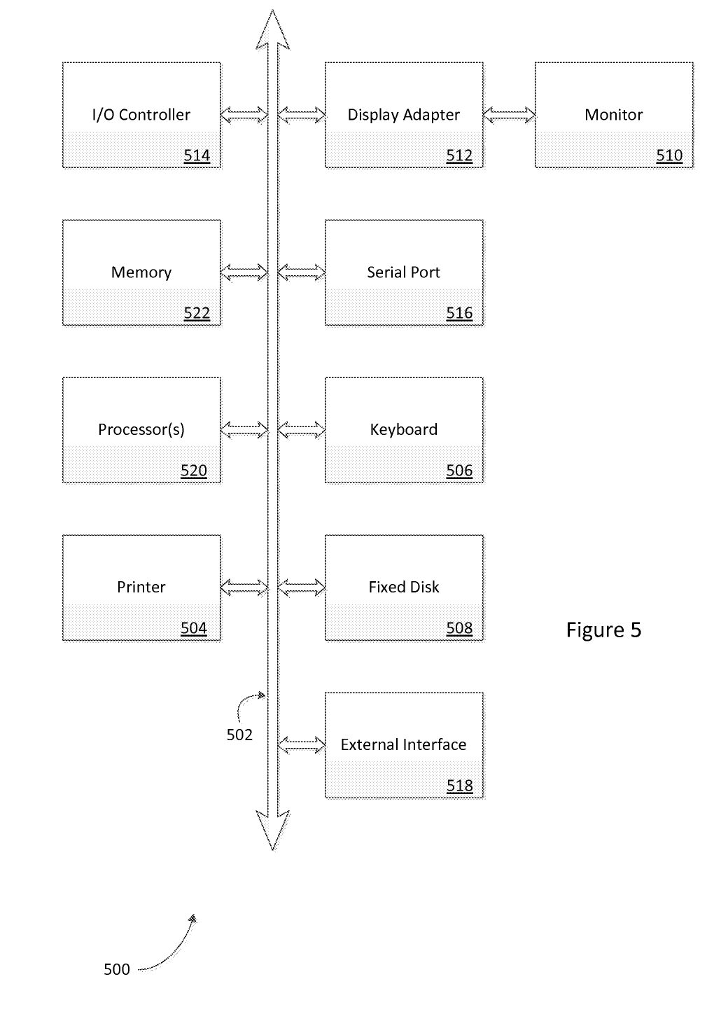

In accordance with at least one embodiment of the invention, the system, apparatus, device, methods, processes, functions, or operations for determining the risk to an Acquirer associated with boarding or providing services to a Merchant may be wholly or partially implemented in the form of a set of instructions executed by one or more programmed computer processors such as a central processing unit (CPU) or microprocessor. Such processors may be incorporated in an apparatus, server, network element, client or other computing device operated by, or in communication with, other components of the system. As an example, FIG. 5 is a diagram illustrating elements or components that may be present in a computing or data processing device 500 configured to implement a process, method, operation, or function in accordance with an embodiment of the invention. The subsystems shown in FIG. 6 are interconnected via a system bus 502. Additional subsystems include a printer 504, a keyboard 506, a fixed disk 508, and a monitor 510, which is coupled to a display adapter 512. Peripherals and input/output (I/O) devices, which couple to an I/O controller 514, can be connected to the computer system by any number of means known in the art, such as a serial port 516. For example, the serial port 516 or an external interface 518 can be utilized to connect the computer device 500 to further devices and/or systems not shown in FIG. 6 including a wide area network such as the Internet, a mouse input device, and/or a scanner. The interconnection via the system bus 502 allows one or more processors 520 to communicate with each subsystem and to control the execution of instructions that may be stored in a system memory 522 and/or the fixed disk 508, as well as the exchange of information between subsystems. The system memory 522 and/or the fixed disk 508 may embody a tangible computer-readable medium.

In some embodiments, the invention may be implemented in the context of a multi-tenant, “cloud” based environment, typically used to develop and provide web services for end users. Note that embodiments of the invention may also be implemented in the context of other computing or operational environments or systems, such as for an individual business data processing system, a remote or on-site data processing system, other form of client-server architecture, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A method of implementing a process to determine a risk posed by a Merchant to an Acquirer, comprising:
accessing information regarding a relationship between the Merchant and its operational environment;
accessing information regarding the business operations of the Merchant;
accessing information regarding the Acquirer's risk control policies;
accessing information regarding the likelihood of a risk event caused by the Merchant;
using the accessed information as an input to an electronic data processing process that generates a model for predicting the likelihood of a specific type of risk event;
accessing information regarding the expected loss to the Acquirer from the specific type of risk event; and
electronically combining the prediction of the likelihood of the specific type of risk event and the expected loss to the Acquirer from the specific type of risk event for one or more types of risk events to generate an aggregate risk score for the Merchant.

2. The method of claim 1, wherein the information regarding a relationship between the Merchant and its operational environment includes one or more of
information regarding the Merchant's location;
information regarding the Merchant's owners and investors; and
information regarding the electronic and physical addresses used by the Merchant.

3. The method of claim 1, wherein the information regarding the business operations of the Merchant includes one or more of
information regarding the Merchant's source of revenue;
information regarding the Merchant's credit history; and
information regarding the Merchant's payment transactions with customers.

4. The method of claim 1, wherein the information regarding the Acquirer's risk control policies includes one or more of
information regarding the Acquirer's actions in response to a risk;
information regarding the Acquirer's previous risk events; and
information regarding the Acquirer's ability to detect a risk.

5. The method of claim 1, wherein the information regarding the likelihood of the risk event includes information regarding previous occurrences of the risk event caused by the Merchant.

6. The method of claim 1, wherein the process that generates the model for predicting the likelihood of the specific type of risk event further comprises one or more of
a machine learning process;
a neural network; and
a statistical analysis.

7. The method of claim 1, wherein generating an aggregate risk score for the Merchant further comprises
determining a model for predicting the likelihood of a specific type of risk event for a plurality of types of risk events;
accessing information regarding the expected loss to the Acquirer from the specific type of risk event for each of the plurality of types of risk events;
calculating a predicted loss to the Acquirer for each of the plurality of types of risk events; and
combining the predicted loss to the Acquirer for each of the plurality of types of risk events.

8. The method of claim 1, wherein the specific type of risk event is one of
a violation of a content compliance condition;
an occurrence of fraudulent behavior;
a breach of security with regards to information or data;
a business continuity failure;
a supply chain failure;
a government fine or sanction;
a civil lawsuit; or
an intellectual property dispute.

9. The method of claim 1, further comprising evaluating the aggregate risk score for the Merchant to determine a recommended action for the Acquirer or Merchant to take to reduce the risk posed by the Merchant.

10. The method of claim 1, further comprising performing the process to determine a risk posed by a Merchant to an Acquirer for a plurality of Merchants and comparing the resulting aggregate risk scores for the plurality of Merchants to a threshold value representing the acceptable risk for the Acquirer.

11. An apparatus for implementing a process to determine a risk posed by a Merchant to an Acquirer, comprising:
a processor programmed to execute a set of instructions;
a data storage element in which the set of instructions are stored, wherein when executed by the processor the set of instructions cause the apparatus to
access information regarding a relationship between the Merchant and its operational environment;
access information regarding the business operations of the Merchant;
access information regarding the Acquirer's risk control policies;
access information regarding the likelihood of a risk event caused by the Merchant;
use the accessed information as an input to an electronic data processing process that generates a model for predicting the likelihood of a specific type of risk event;
access information regarding the expected loss to the Acquirer from the specific type of risk event; and
combine the prediction of the likelihood of the specific type of risk event and the expected loss to the Acquirer from the specific type of risk event for one or more types of risk events to generate an aggregate risk score for the Merchant.

12. The apparatus of claim 11, wherein the information regarding a relationship between the Merchant and its operational environment includes one or more of
information regarding the Merchant's location;
information regarding the Merchant's owners and investors; and
information regarding the electronic and physical addresses used by the Merchant.

13. The apparatus of claim 11, wherein the information regarding the business operations of the Merchant includes one or more of
information regarding the Merchant's source of revenue;
information regarding the Merchant's credit history; and
information regarding the Merchant's payment transactions with customers.

14. The apparatus of claim 11, wherein the information regarding the Acquirer's risk control policies includes one or more of
information regarding the Acquirer's actions in response to a risk;
information regarding the Acquirer's previous risk events; and
information regarding the Acquirer's ability to detect a risk.

15. The apparatus of claim 11, wherein the information regarding the likelihood of the risk event includes information regarding previous occurrences of the risk event caused by the Merchant.

16. The apparatus of claim 11, wherein the process that generates the model for predicting the likelihood of the specific type of risk event further comprises one or more of
a machine learning process;
a neural network; and
a statistical analysis.

17. The apparatus of claim 11, wherein generating an aggregate risk score for the Merchant further comprises
determining a model for predicting the likelihood of a specific type of risk event for a plurality of types of risk events;
accessing information regarding the expected loss to the Acquirer from the specific type of risk event for each of the plurality of types of risk events;
calculating a predicted loss to the Acquirer for each of the plurality of types of risk events; and
combining the predicted loss to the Acquirer for each of the plurality of types of risk events.

18. The apparatus of claim 11, wherein the specific type of risk event is one of
a violation of a content compliance condition;
an occurrence of fraudulent behavior;
a breach of security with regards to information or data;
a business continuity failure;
a supply chain failure;
a government fine or sanction;
a civil lawsuit; or
an intellectual property dispute.

19. The apparatus of claim 11, wherein the set of instructions cause the apparatus to evaluate the aggregate risk score for the Merchant to determine a recommended action for the Acquirer or Merchant to take to reduce the risk posed by the Merchant.

20. The apparatus of claim 11, wherein the set of instructions cause the apparatus to perform the process to determine a risk posed by a Merchant to an Acquirer for a plurality of Merchants and compare the resulting aggregate risk scores for the plurality of Merchants to a threshold value representing the acceptable risk for the Acquirer.
